(19) United States
(12) Patent Application Publication
(10) Pub. No.: US 2026/0320879 A1
(43) Pub. Date: Oct. 15, 2026

(54) APPARATUS AND METHOD FOR EVALUATING DENSITY OF CROWD BASED ON HETEROGENEOUS DATA FUSION

(71) Applicant: KOREA INSTITUTE OF SCIENCE AND TECHNOLOGY, Seoul (KR)

(72) Inventors: Ig Jae KIM, Seoul (KR); Haesol PARK, Seoul (KR); Junghyun CHO, Seoul (KR); Heeseung CHOI, Seoul (KR); Gi Pyo NAM, Seoul (KR); Haksub KIM, Seoul (KR); Hyungjoo JUNG, Seoul (KR); Yonghun CHOI, Seoul (KR)

(73) Assignee: KOREA INSTITUTE OF SCIENCE AND TECHNOLOGY, Seoul (KR)

(21) Appl. No.: 19/340,239

(22) Filed: Sep. 25, 2025

(30) Foreign Application Priority Data
Sep. 27, 2024 (KR) 10-2024-0131795

(51) Int. Cl. G06T 11/65; G06T 7/77; G06V 10/62; G06V 10/776; G06V 10/82; G06V 20/52

(52) U.S. Cl. CPC G06T 11/65; G06T 7/77; G06V 10/776; G06V 20/53; G06T 2207/30196; G06T 2207/30242; G06V 10/62; G06V 10/82

(57) ABSTRACT

According to one embodiment, an apparatus for evaluating a density of crowd based on heterogeneous data fusion includes one or more processors, and a memory for storing an instruction executed by the one or more processors, in which the one or more processors are configured to receive heterogeneous measurement data related to the density of crowd from different data sources, the measurement data having different sampling periods, perform temporal alignment on the heterogeneous measurement data, extract measurement data at a time point matching a preset sync time from the heterogeneous measurement data by type of data source, fuse measurement data at a sync time matching the sync time extracted by type of data source to generate fused data, and evaluate the density of crowd based on the fused data.

### FIELD OF THE INVENTION

The disclosed embodiments relate to a technology for generating an integrated density of crowd map by fusing heterogeneous data with different sampling periods.

### DESCRIPTION OF NATIONALLY SUPPORTED RESEARCH AND DEVELOPMENT

This study is supported by the National Police Agency and the Ministry of the Interior and Safety [Project No. RS-2024-00405100, Project Name: Development of Science and Technology-Based Density of crowd Management Technology, Project Title: Development of Science and Technology-Based Density of crowd Management Technology].

### DESCRIPTION OF THE RELATED ART

Large-scale events pose a significant risk of casualties. When the event management authority is unclear, the potential for casualties increases. This is because decentralized responsibility can lead to inadequate monitoring and delayed emergency response.

To address the above issues, several technologies are being utilized to detect overcrowded areas. The first is a technology that utilizes CCTV footage. However, the CCTV footage suffers from the problem of not being able to cover blind spots.

The second is a technology that utilizes data provided by mobile carriers. This technology estimates population statistics using real-time floating population data provided by the mobile carriers. However, the population statistics are analyzed only over a broad area within the jurisdiction of a base station, making it difficult to determine population density in narrow spaces that require close observation.

Some seek to improve the incompleteness of monitoring by comprehensively utilizing the two technologies described above. However, information from the two technologies should be checked alternately, and it is difficult to grasp the population density at a glance because the two technologies cover different areas.

Therefore, density of crowd data should be understood in an integrated manner. While useful information is collected simultaneously from various sources, the technology to compress the information into a single data set and comprehensively assess crowd conditions remains inadequate.

### PRIOR ART DOCUMENTS

### Patent Documents (Patent Document 1) Korean Patent No. 10-1790269 (Published Oct. 26, 2017)

### SUMMARY OF THE INVENTION

### Problems to be Solved

The disclosed embodiments are a technology for evaluating density of crowd by weighting and fusing real and/or virtual values of heterogeneous measurement data having different sampling periods.

### Means to Solve the Problems

According to one embodiment, there is provided an apparatus for evaluating a density of crowd based on heterogeneous data fusion, the apparatus including: one or more processors; and a memory for storing an instruction executed by the one or more processors, in which the one or more processors are configured to receive heterogeneous measurement data related to the density of crowd from different data sources, the heterogeneous measurement data having different sampling periods, perform temporal alignment on the heterogeneous measurement data, extract measurement data at a time point matching a preset sync time from the heterogeneous measurement data by type of data source, fuse measurement data at a sync time matching the sync time extracted by type of data source to generate fused data, and evaluate the density of crowd based on the fused data.

The heterogeneous measurement data may include first data collected by an image sensor of a closed-circuit camera television (CCTV) that captures a target area, second data collected and provided by a mobile carrier through a network installed in the target area, and third data collected by at least one of a Wi-Fi sensor and a Bluetooth sensor installed in the target area.

The one or more processors may be configured to input some or all of actual data measured cumulatively from one data source of the different data sources into a first learning model when the one data source fails to receive data measured at the sync time and generate virtual data expected to be measured from the one data source at the sync time.

The one or more processors may be configured to extract the virtual data by replacing the actual data measured from the one data source with the extracted data at the sync time.

The one or more processors may be configured to input extracted data at the sync time into a second learning model to calculate reliability of each data source.

The one or more processors may be configured to calculate an attribute related to situation, time, weather, location, and/or density of the extracted data at the sync time, for each type of data source using the second learning model, and calculate the reliability of the data source for each type based on the attribute.

The second learning model may be trained to calculate a reliability for at least one of the second data and the third data higher than a reliability of the first data when the attribute of the extracted data at the sync time is classified as nighttime.

The one or more processors may be configured to fuse the extracted data at the sync time by applying a weight set based on the reliability.

The second learning model may be trained via supervised learning with the target area and GPS data corresponding to the target area as a pair of ground truth values.

The one or more processors may be configured to perform spatial alignment on the heterogeneous measurement data so that target areas expressed in the heterogeneous measurement data are aligned.

According to one embodiment, there is provided a method performed by an apparatus for evaluating a density of crowd based on heterogeneous data fusion including one or more processors and a memory for storing an instruction executed by the one or more processors, the method including: receiving heterogeneous measurement data related to the density of crowd from different data sources, the heterogeneous measurement data having different sampling periods, performing temporal alignment on the heterogeneous measurement data, extracting measurement data at a time point matching a preset sync time from the heterogeneous measurement data by type of data source, fusing measurement data at a sync time matching the sync time extracted by type of data source to generate fused data, and evaluating the density of crowd based on the fused data.

The heterogeneous measurement data may include first data collected by an image sensor of a closed-circuit camera television (CCTV) that captures a target area, second data collected and provided by a mobile carrier through a network installed in the target area, and third data collected by at least one of a Wi-Fi sensor and a Bluetooth sensor installed in the target area.

The extracting may include inputting some or all of actual data measured cumulatively from one data source of the different data sources into a first learning model when the one data source fails to receive data measured at the sync time and generating virtual data expected to be measured from the one data source at the sync time.

The extracting may include extracting the virtual data by replacing the actual data measured from the one data source with the extracted data at the sync time.

The generating may include inputting extracted data at the sync time into a second learning model to calculate reliability of each data source.

The generating may include calculating an attribute related to situation, time, weather, location, and/or density of the extracted data at the sync time, for each type of data source using the second learning model, and calculating the reliability of the data source for each type based on the attribute.

The second learning model may be trained to calculate the reliability for at least one of the second data and the third data higher than a reliability of the first data when the attribute of the extracted data at the sync time is classified as nighttime.

The generating may include fusing the extracted data at the sync time by applying a weight set based on the reliability.

The second learning model may be trained via supervised learning with the target area and GPS data corresponding to the target area as a pair of ground truth values.

The method may further include performing spatial alignment on the heterogeneous measurement data so that target areas expressed in the heterogeneous measurement data are aligned.

### Advantageous Effects

The disclosed embodiments evaluate density of crowd by fusing heterogeneous measurement data obtained from different data sources, thereby mutually compensating for limitations of the measurement data and enabling more accurate analysis.

The disclosed embodiments generate the virtual value and uses the virtual value instead of missing data at the sync time, thereby resolving incompleteness of measurement data and enabling more precise dense analysis.

The disclosed embodiments evaluate reliability according to the characteristics of measurement data and weightily fuse measurement data according to the reliability, thereby reducing false detections in dense analysis and improving the reliability of results.

### BRIEF DESCRIPTION OF THE DRAWINGS

FIG. 1 is a block diagram illustrating an apparatus for evaluating a density of crowd based on heterogeneous data fusion according to one embodiment.

FIG. 2 is an exemplary diagram illustrating types of heterogeneous measurement data.

FIG. 3 is a diagram illustrating a process of extracting measurement data at a sync time.

FIG. 4 is a diagram illustrating a process of calculating reliability of a data source.

FIG. 5 is a diagram illustrating a result of synthesizing measurement data at the sync time.

FIG. 6 is a flowchart illustrating a method for evaluating a density of crowd based on heterogeneous data fusion according to one embodiment.

### DETAILED DESCRIPTION OF THE INVENTION

Hereinafter, specific embodiments of one embodiment will be described with reference to drawings. The following detailed description is provided to facilitate a comprehensive understanding of the methods, devices, and/or systems described herein. However, this is merely an example and the present disclosure is not limited thereto.

In describing embodiments, when a detailed description of a known technology related to the present disclosure is determined to unnecessarily obscure the gist of one embodiment, the detailed description will be omitted. In addition, the terms described below are terms defined in consideration of their functions in the present disclosure, and this may vary depending on the intention or custom of the user or operator. Therefore, the definitions should be made based on the contents throughout detailed description of the present disclosure. The terminology used in the detailed description is only for the purpose of describing embodiments and should never be limited. Unless clearly used otherwise, the singular form includes the plural form. In this description, expressions such as “including” or “having” are intended to indicate certain components, numbers, steps, operations, elements, parts, or combinations thereof, and should not be construed to exclude the presence or possibility of one or more other components, numbers, steps, operations, elements, parts, or combinations thereof other than those described.

Although terms like “first” and “second” are used to describe various components, these components are not limited by these terms. These terms are used merely to distinguish one component from another. Therefore, a “first” component referred to below may also be a “second” component within the technical scope of the present disclosure.

Additionally, the embodiments described herein may have aspects that are entirely hardware, partially hardware and partially software, or entirely software.

In the present specification, the terms “unit” and “device” refer to a combination of hardware, software, or the like. For example, the terms “unit” and “device” may refer to the integrated photonic circuit itself or software connected to hardware to drive the integrated photonic circuit.

The terms used in the present specification are defined as follows.

A sync time refers to the times {t₀+kΔ} generated by adding a reference time t₀ and a predefined interval Δ, and Δ may be set in the range of 10 seconds or more and 10 minutes or less.

A window width refers to a range of reception delay allowed for a specific data source to be temporally aligned with the sync time, and may be set in the range of Δ/4 to 3Δ depending on the data source.

Virtual data may be defined as a predicted value calculated by applying a time series prediction model, interpolation, or Bayesian filtering algorithm when missing data occurs.

“Reliability” is a scalar value between 0 and 1 calculated for each data source, and may refer to a weight conditionally assigned to contextual information such as time zone, weather, location, and event situation.

Fused data may refer to an integrated density of crowd map obtained by fusing data from different sources by applying the reliability as a weight.

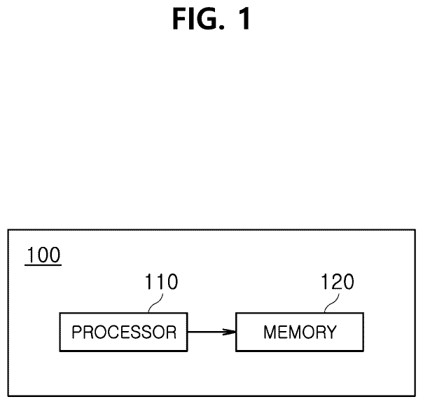

FIG. 1 is a block diagram illustrating an apparatus for evaluating a density of crowd based on heterogeneous data fusion according to one embodiment.

Referring to FIG. 1, the apparatus for evaluating for density of crowd based on heterogeneous data fusion includes a processor and memory.

The processor receives heterogeneous measurement data related to the density of crowd from different data sources.

The heterogeneous measurement data may include first data collected by an image sensor of a closed-circuit camera television (CCTV) that captures a target area.

The heterogeneous measurement data may include second data collected and provided by a mobile carrier through a network installed in the target area.

The heterogeneous measurement data may include third data collected by at least one of a Wi-Fi sensor and a Bluetooth sensor provided in the target area.

The heterogeneous measurement data may further include information about population density, as well as attributes of individuals captured in the measurement data and attributes of sensors.

For example, heterogeneous measurement data may include information about the gender and age of the population density. As another example, the heterogeneous measurement data may include the location of the sensor that serves as the measurement source. In this case, the heterogeneous measurement data may have different sampling periods. The sampling period may refer to the frequency or interval at which the data source measures data and transmits the data to the processor, or the processor receives data from the data source. The processor performs temporal alignment on the heterogeneous measurement data. The processor may arrange the heterogeneous measurement data in chronological order through a timestamp formed for each data point of the heterogeneous measurement data. In this case, it is preferable for the processor to arrange measurement data of the same type.

Specifically, the processor may map heterogeneous measurement data onto a common synchronization grid {t₀+k·Δ} based on the timestamp assigned to each data point. The closest data point within a specified window width (for example, Δ/2) within the same data source may be selected, or the value at the sync time may be calculated by linearly interpolating between adjacent data, or by applying a pre-trained time series prediction model (for example, GRU, TCN-based model).

The processor extracts measurement data from the heterogeneous measurement data at a time point that matches a preset sync time point, by type of data source.

The processor may extract data at the required time by comparing the time stamp assigned to each data point of the heterogeneous measurement data with the preset sync time. The processor may also generate virtual data to account for missing data. For example, when the processor cannot receive the measurement data at the sync time, the processor generates virtual data to account for the missing data.

For example, when the processor fails to receive data measured at the preset sync time from one data source, some or all of the actual data measured cumulatively from the one data source may be input into a first learning model to generate the virtual data expected to be measured at the sync time from the one data source. In this case, the virtual data may be used as the measurement data at the sync time of the one data source.

As a specific example, when the processor fails to receive value of some data sources at a specific sync time, the processor may input the immediately preceding L (for example, 5 to 20) accumulated data of the sources into the first learning model to generate the predicted value. Here, the first learning model may be implemented as a time series prediction network (GRU, LSTM, or Temporal Convolutional Network), and may be trained so that the difference between the predicted value and the actual value satisfies a predetermined threshold (for example, mean absolute error of 5% or less) during the learning process. Meanwhile, when the generated predicted value is out of the threshold, a fallback rule may be applied to the first learning model to replace the predicted value with the closest actual data.

The processor may perform spatial alignment on the measurement data so that target areas represented in the heterogeneous measurement data are aligned.

The processor may define the boundary of the target area to be analyzed from the heterogeneous measurement data and perform spatial alignment by aligning the data points within the boundary.

The processor may generate fused data by fusing data matching the sync time and extracted by type of the data source, hereinafter, the measurement data at the sync time.

To this end, first, the processor may store a transformation parameter in a memory for transforming the coordinate system of each data source into a common coordinate system (for example, a WGS84-based UTM coordinate system). For example, in the case of CCTV images, the image coordinates may be back-projected into actual street coordinates using the camera's internal and external parameters (focal length, principal point, distortion coefficients), and in the case of mobile communication data, the base station's coverage polygon may be mapped to the coordinate system. In this way, the processor may perform the spatial alignment to synthesize data from different sources in the same physical area unit (for example, a 2 m×2 m tile).

The processor may generate the fused data based on weights assigned to each type of data source. In this case, the weights may be set based on the reliability of the data source. The processor may normalize the reliability of each data source and convert the reliability into the weight. For example, for a set of data sources S, if the reliability of the source s is rs, the weight ws may be defined as rs=rs/Σ(rs). For each region tile (i, j), a final density value D[i, j] may be calculated as Σs ws·fs(x*s[i, j]), where fs may represent a density transformation function for each data source (for example, a function that converts the number of terminals or population density to RSSI).

The processor may input extracted data at the sync time into a second learning model to calculate the reliability of the data source.

The second learning model is a multilayer neural network (MLP)-based classifier that may convert an attribute (time zone: day/night, weather: clear/rain/snow, location: city/open space, event situation: performance/emergency, or the like) extracted from the input data into a vector and then calculate a score between 0 and 1 using a Softmax or sigmoid function.

Here, the second learning model may be trained via supervised learning to extract one or more attributes that may be extracted from the input data with the target area and the GPS data corresponding to the target area as a pair of ground truth values, and calculate the reliability of the measurement data based on the attributes.

The second learning model may be trained to extract features related to the situation, time, weather, location, and/or density of the input data.

Preferably, the second learning model is trained to calculate reliability by distinguishing the types of measurement data even when multiple types of measurement data are input.

The second learning model may calculate the reliability based on the attributes extracted from the input data.

For example, when the time attribute of extracted data at the sync time is classified as nighttime, the second learning model may be trained to calculate a reliability for at least one of the second data and third data higher than a reliability of the first data. Since CCTV footage visibility is reduced during nighttime hours, the learning may be performed so that the reliability of the CCTV data is adjusted to be lowered while the reliability of mobile carrier and Wi-Fi sensor data is adjusted to be relatively increased.

From this, the second learning model may be robust to problems such as reduced visibility, increased noise, and reduced object identification that occur in CCTV images captured at nighttime.

As another example, the second learning model may be trained to calculate the reliability of the second and third data lower than the reliability of the first data when the location attribute of the extracted data at the sync time is classified as a city.

From this, the second learning model may be robust to inaccurate mobile traffic detection due to signal reflection, signal blocking, and signal overlapping caused by buildings existing in the city.

The processor evaluates density of crowd based on the fused data. In this case, the processor may generate an integrated density of crowd map based on the fused data, and evaluate the density of crowd of the target area based on the generated integrated density of crowd map.

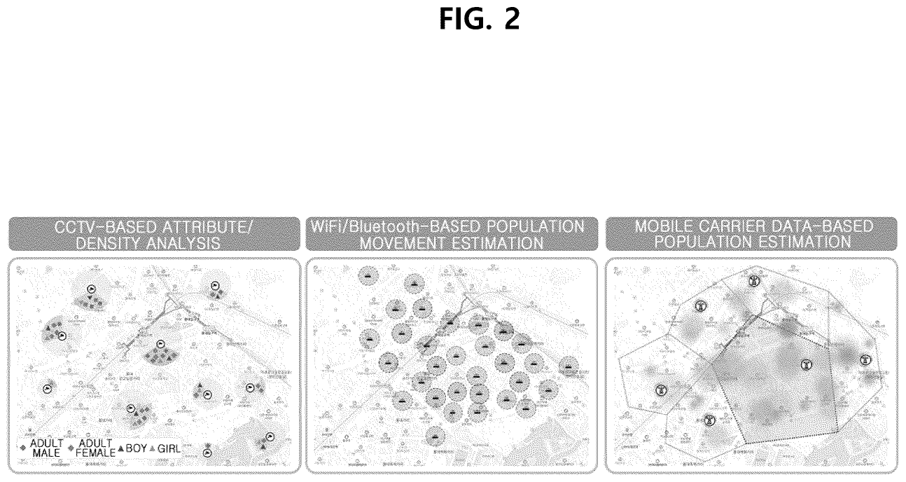

FIG. 2 is an exemplary diagram illustrating the types of heterogeneous measurement data.

Referring to FIG. 2, first to third data are presented as measurement data collected from various sources.

The measurement data may include the first data measured by a CCTV sensor.

The first data may be provided in discrete form as video frames or images captured by the CCTV sensor at a preset sampling period.

The first data may include not only the image itself, which is a direct photograph of an individual located in the target area, but also the attribute (for example, gender, age) of the individual that appears in the image.

The second data may include mobile traffic data analyzed by the network (for example, a base station) of the mobile carrier. The mobile traffic data may be analyzed based on the access, movement patterns, and data usage of users within the range allocated to the base station.

The second data may include not only the mobile traffic data itself, but also population density information generated using the mobile traffic. In this case, the second data may be provided in discrete form.

The second data may be displayed on map data based on the target area using mobile traffic data (for example, call records, location data) collected in the target area, with population density distinguished by color intensity.

The third data may include mobile traffic data measured by Wi-Fi sensors and Bluetooth sensors installed in the target area.

The third data may include not only the mobile traffic data itself, but also information on estimated movement of people generated using mobile traffic data. In this case, the third data may be provided in discrete form.

The third data may display high and low population density on the map data based on the target area by using the mobile traffic data (for example, number of connected devices, signal strength, movement path) collected in the target area with color-coding.

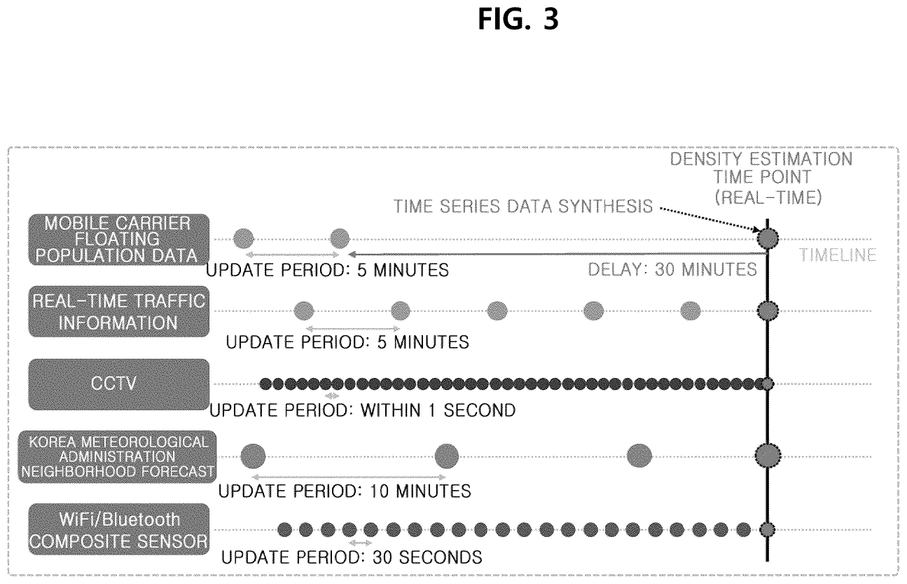

FIG. 3 is a diagram illustrating the process of extracting measurement data at the sync time.

The extraction process is as follows. First, the processor continuously receives the heterogeneous measurement data. In this case, the heterogeneous measurement data is captured in real time and transmitted to the processor with some delay.

Here, the heterogeneous measurement data is multi-modal data received from various sources, as illustrated in FIG. 3, and the processor receives the data at specific intervals according to a sampling period determined by each data source.

For example, floating population data provided by the mobile carrier may be received cumulatively with a sampling period of 5 minutes, and images provided from CCTV sensors may be received cumulatively with a sampling period of 1 second.

Thereafter, the processor may organize the heterogeneous measurement data according to the time each data point is received or generated, and may arrange the heterogeneous measurement data chronologically in chronological order.

In this case, when the reception time or creation time of the heterogeneous measurement data matches the sync time, the corresponding data point may be treated as the measurement data at the sync time and extracted as the fusion target.

Here, the sync time may be a preset time, for example, a time point when the target region is expected to be densely populated. As a specific example, the sync time may be set to occur at preset intervals, starting at the start time of an event occurring in the target region. For example, when a festival is scheduled to open in the target region at 4 PM, the sync time may be set to every 10 minutes starting at 3 PM.

However, when the missing data occurs at the specified sync time due to the delay time of the floating population data provided by the mobile carrier, and the processor cannot receive the measurement data at the sync time from the mobile carrier, the processor inputs the measurement data received from the mobile carrier into the first learning model to obtain virtual data predicted to be measured by the mobile carrier at the specified sync time, and the virtual data may be used as the measurement data at the sync time.

From this, the processor may extract the measurement data at the sync time from all types of sensors even when there is the missing data at the sync time.

Meanwhile, in FIG. 3, the heterogeneous data is described as floating population data provided by the mobile carrier, real-time traffic information, CCTV images, weather forecasts provided by the Korea Meteorological Administration, and measurement values measured from Wi-Fi and Bluetooth sensors. However, this is merely exemplary, and any other data capable of measuring population density is intended to be included in the heterogeneous data.

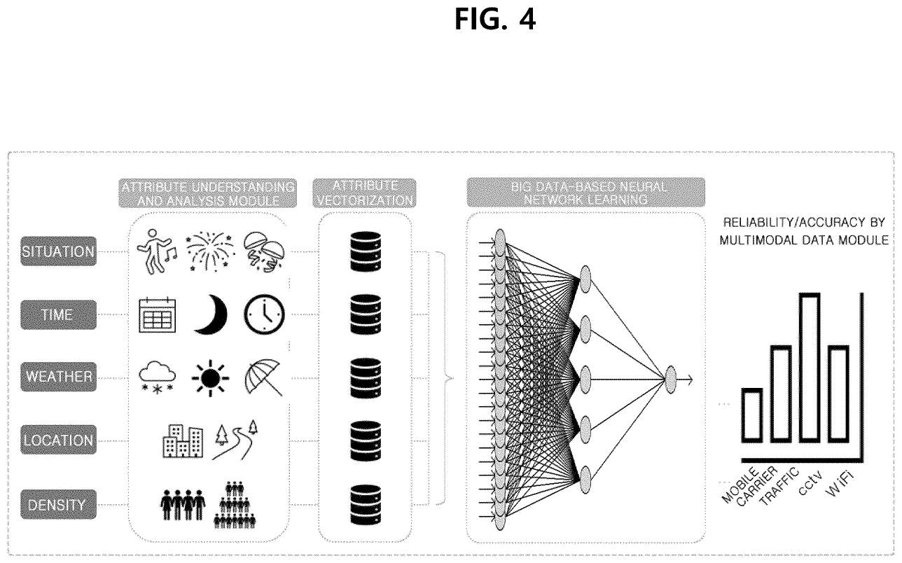

FIG. 4 is a diagram explaining the process of calculating the reliability of the data source.

The processor may input the measurement data at the sync time into the second learning model to extract the corresponding attribute.

Specifically, the processor may extract various visual attributes, including the situation, time, weather, location, and density, included in the measurement data at the sync time through the second learning model.

Here, the situational attributes may include emergency situations where people are evacuating in a hurry or in a state of chaos, event situations where specific events such as festivals or sporting events are taking place, waiting situations where people are lining up or waiting, or the like.

As another example, the time attributes may be categorized by time zone including daytime and nighttime or day of the week including weekdays. As another example, the weather attributes may be categorized by cloudy, clear, and rainy. As another example, the location attributes may be categorized by urban and natural environments. The dense attributes may be categorized by low and high.

The processor may calculate the reliability of each source of the measurement data by embedding the attribute extracted from the measurement data at the sync time into the vector through the second learning model.

The second learning model may be trained via supervised learning based on high-precision location data, such as MDT-GNSS or TMAP, along with the attribute vector extracted from the learning image. The second learning model may be trained to reduce errors compared to image-based density estimation results.

Meanwhile, the second learning model is preferably comprised of a multilayer neural network (MLP) to process the embedding extracted from the image. The second learning model extracts patterns from the input data through each layer, and the final layer may calculate a reliability score between 0 and 1.

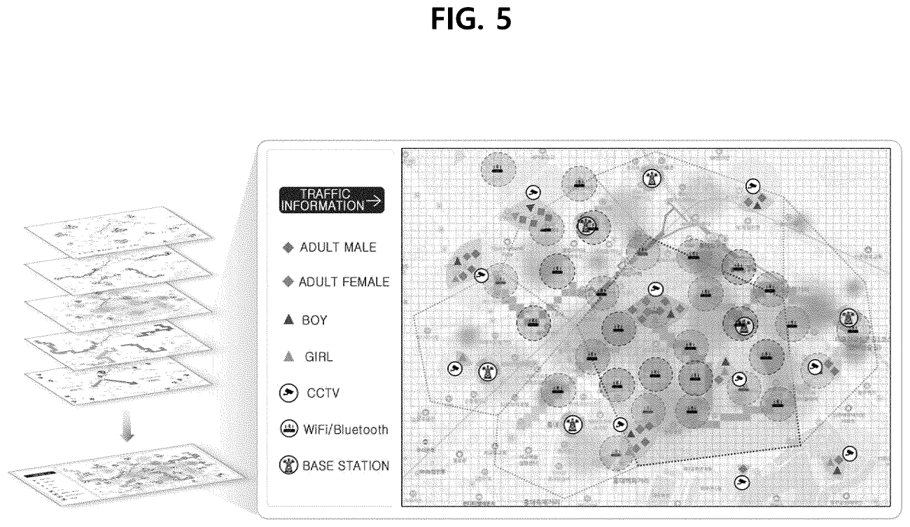

FIG. 5 is a diagram explaining the result of synthesizing the measurement data at the sync time.

The processor may generate the fused data by weighting and fusing the extracted data at the sync time. The fused data may then become an integrated density of crowd map.

The processor may fuse the extracted data at the sync time by applying the weight. The weight may be set based on the reliability calculated as described above. When the reliability is high, the weight may be set high to ensure a high proportion of fused data generation.

The processor may incrementally fuse the extracted data at the sync time by applying the weight. Specifically, the processor may incrementally fuse extracted data at the sync time by excluding overlapping portions and adding new information.

From this, the processor may generate an integrated crowd map that includes information on people, crowds, scene attributes, population movement, and crowd flow by adding information on the extracted attributes as well as additional attributes included in the heterogeneous measurement data.

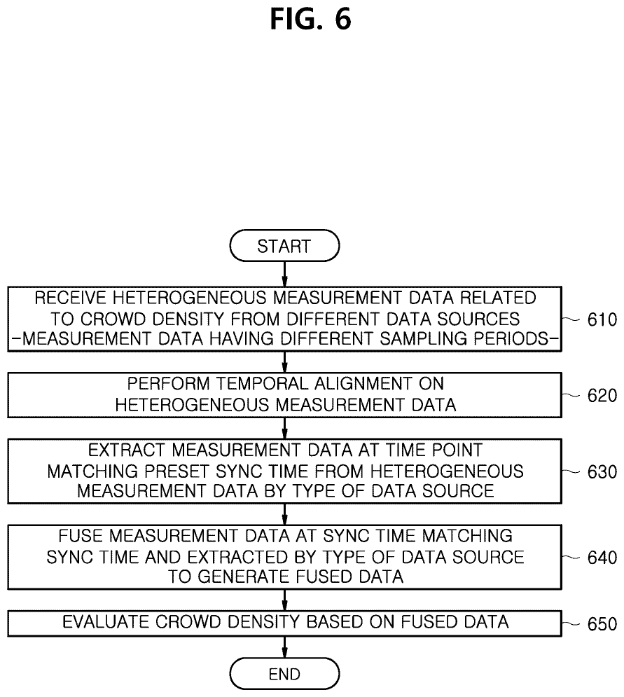

FIG. 6 is a flowchart illustrating a method for evaluating a density of crowd based on heterogeneous data fusion according to one embodiment.

The method of FIG. 6 may be performed by the apparatus for evaluating a density of crowd based on heterogeneous data fusion of FIG. 1.

First, the apparatus for evaluating a density of crowd based on heterogeneous data fusion receives heterogeneous measurement data related to the density of crowd from different data sources (610).

In this case, the measurement data have different sampling periods.

Afterwards, the apparatus for evaluating a density of crowd based on heterogeneous data fusion performs temporal alignment on heterogeneous measurement data (620).

Afterwards, the apparatus for evaluating a density of crowd based on heterogeneous data fusion extracts the measurement data at the time point matching a preset sync time from heterogeneous measurement data by type of data source (630).

Thereafter, the apparatus for evaluating a density of crowd based on heterogeneous data fusion fuses the measurement data at the sync time matching the sync time and extracted by type of data source to generate the fused data (640).

Afterwards, the apparatus for evaluating a density of crowd based on heterogeneous data fusion evaluates the density of crowd based on the fused data (650).

Meanwhile, although the method of FIG. 6 is described as being divided into a plurality of steps, at least some of the steps may be performed in a different order, performed together with other steps, omitted, performed by dividing into detailed steps, or performed by adding one or more steps not illustrated.

While representative embodiments of the present disclosure have been described in detail above, those skilled in the art will appreciate that various modifications to the above-described embodiments are possible without departing from the scope of the present disclosure. Therefore, the scope of the present disclosure should not be limited to the described embodiments, but should be determined not only by the claims set forth below but also by equivalents thereof.

### REFERENCE SIGNS

100: apparatus for evaluating density of crowd based on heterogeneous data fusion
110: processor
120: memory

What is claimed is:

1. An apparatus for evaluating a density of crowd based on heterogeneous data fusion, the apparatus comprising:
one or more processors; and
a memory for storing an instruction executed by the one or more processors,
wherein the one or more processors are configured to
receive heterogeneous measurement data related to the density of crowd from different data sources, the heterogeneous measurement data having different sampling periods,
perform temporal alignment on the heterogeneous measurement data,
extract measurement data at a time point matching a preset sync time from the heterogeneous measurement data by type of data source,
fuse measurement data at a sync time matching the sync time extracted by type of data source to generate fused data, and
evaluate the density of crowd based on the fused data.

2. The apparatus of claim 1, wherein the heterogeneous measurement data includes
first data collected by an image sensor of a closed-circuit camera television (CCTV) that captures a target area,
second data collected and provided by a mobile carrier through a network installed in the target area, and
third data collected by at least one of a Wi-Fi sensor and a Bluetooth sensor installed in the target area.

3. The apparatus of claim 1, wherein the one or more processors are configured to input some or all of actual data measured cumulatively from one data source of the different data sources into a first learning model when the one data source fails to receive data measured at the sync time and generate virtual data expected to be measured from the one data source at the sync time.

4. The apparatus of claim 3, wherein the one or more processors are configured to extract the virtual data by replacing the actual data measured from the one data source with the extracted data at the sync time.

5. The apparatus of claim 2, wherein the one or more processors are configured to input extracted data at the sync time into a second learning model to calculate reliability of each data source.

6. The apparatus of claim 5, wherein the one or more processors are configured to
calculate an attribute related to situation, time, weather, location, and/or density of the extracted data at the sync time, for each type of data source using the second learning model, and
calculate the reliability of the data source for each type based on the attribute.

7. The apparatus of claim 5, wherein the second learning model is trained to calculate a reliability for at least one of the second data and the third data higher than a reliability of the first data when the attribute of the extracted data at the sync time is classified as nighttime.

8. The apparatus of claim 5, wherein the one or more processors are configured to fuse the extracted data at the sync time by applying a weight set based on the reliability.

9. The apparatus of claim 5, wherein the second learning model is trained via supervised learning with the target area and GPS data corresponding to the target area as a pair of ground truth values.

10. The apparatus of claim 1, wherein the one or more processors are configured to perform spatial alignment on the heterogeneous measurement data so that target areas expressed in the heterogeneous measurement data are aligned.

11. A method performed by an apparatus for evaluating a density of crowd based on heterogeneous data fusion including one or more processors and a memory for storing an instruction executed by the one or more processors, the method comprising:
receiving heterogeneous measurement data related to the density of crowd from different data sources, the heterogeneous measurement data having different sampling periods,
performing temporal alignment on the heterogeneous measurement data,
extracting measurement data at a time point matching a preset sync time from the heterogeneous measurement data by type of data source,
fusing measurement data at a sync time matching the sync time extracted by type of data source to generate fused data, and
evaluating the density of crowd based on the fused data.

12. The method of claim 11, wherein the heterogeneous measurement data includes
first data collected by an image sensor of a closed-circuit camera television (CCTV) that captures a target area,
second data collected and provided by a mobile carrier through a network installed in the target area, and
third data collected by at least one of a Wi-Fi sensor and a Bluetooth sensor installed in the target area.

13. The method of claim 11, wherein the extracting includes inputting some or all of actual data measured cumulatively from one data source of the different data sources into a first learning model when the one data source fails to receive data measured at the sync time and generating virtual data expected to be measured from the one data source at the sync time.

14. The method of claim 13, wherein the extracting includes extracting the virtual data by replacing the actual data measured from the one data source with the extracted data at the sync time.

15. The method of claim 12, wherein the generating includes inputting extracted data at the sync time into a second learning model to calculate reliability of each data source.

16. The method of claim 15, wherein the generating includes
calculating an attribute related to situation, time, weather, location, and/or density of the extracted data at the sync time, for each type of data source using the second learning model, and
calculating the reliability of the data source for each type based on the attribute.

17. The method of claim 15, wherein the second learning model is trained to calculate a reliability for at least one of the second data and the third data higher than a reliability of the first data when the attribute of the extracted data at the sync time is classified as nighttime.

18. The method of claim 15, wherein the generating includes fusing the extracted data at the sync time by applying a weight set based on the reliability.

19. The method of claim 15, wherein the second learning model is trained via supervised learning with the target area and GPS data corresponding to the target area as a pair of ground truth values.

20. An apparatus for evaluating a density of crowd based on heterogeneous data fusion, the apparatus comprising:
one or more processors; and
a memory for storing an instruction executed by the one or more processors,
wherein the one or more processors are configured to
receive heterogeneous measurement data having different sampling periods provided from at least two heterogeneous sources of a CCTV, a mobile communication network, Wi-Fi, and a Bluetooth sensor,
align the measurement data to a synchronization grid defined by a reference time (t₀) and an interval (Δ) and generate virtual data using a time-series prediction model using the most recent L data when missing data is present,
input the aligned data into a second learning model to calculate reliability for each data source based on a contextual attribute such as time zone, weather, and location,
fuse the aligned data using the reliability as a weight to generate a synthetic density map, and
evaluate the density of crowd of a target area based on the synthetic density map.
